(19) United States
(12) Patent Application Publication
(10) Pub. No.: US 2026/0187045 A1
(43) Pub. Date: Jul. 2, 2026

(54) LARGE OBJECTS MANAGEMENT IN A PARALLEL SYSTEM

(71) Applicant: Teradata US, Inc., San Diego, CA (US)

(72) Inventors: John Douglas Frazier, Ramona, CA (US); Sukumar Burra, Plano, TX (US)

(73) Assignee: Teradata US, Inc., San Diego, CA (US)

(21) Appl. No.: 19/007,375

(22) Filed: Dec. 31, 2024

(51) Int. Cl. G06F 16/22

(52) U.S. Cl. CPC G06F 16/2219

(57) ABSTRACT

A system may include a storage device. The system further includes a plurality of processing nodes in communication with the storage device. Each processing node executes at least one unit of parallelism. At least one processing node generates at least one large object (“LOB”). The at least one processing node identifies a multi-thread storage system. The at least one processing node stores the LOB in the multi-thread storage system. The at least one processing node generates a unique identifier that indicates the location of the LOB in the multi-thread storage system. The at least one processing node stores unique identifier. The unique identifier is accessible by all units of parallelism. A method and computer-readable medium are also disclosed.

### BACKGROUND

The arrival of artificial intelligence (“AI”) in database management has increased the power of database processing, however, some limitations exist. For example, large objects (“LOBs”) provide beneficial tools to a database management system, but there is inefficiency and complexity in creating, managing, and referencing within parallel databases. In particular large language models (“LLMs”) prove difficult in a parallel system. In addition to the managing of the LLMs, serving of the data in parallel from one unit of parallelism which has stored the LOB to all the other units of parallelism represents a bottleneck. The serving mechanism is limited by a message transmission system that is limited to a few megabytes (“MB”) and does not use an optimized storage protocol for serving the data.

Because the management of LOBs in a parallel database system is inefficient, it would be desirable to provide a manner in which to manage LOBs in parallel database system that eliminates serving the LOB data within the database.

### SUMMARY

According to one aspect of the disclosure, a system may include a storage device. The system may further include a plurality of processing nodes in communication with the storage device. Each processing node may be configured to execute at least one unit of parallelism. At least one processing node may generate at least one large object (“LOB”). The at least one processing node may identify a multi-thread storage system. The at least one processing node may store the LOB in the multi-thread storage system. The at least one processing node may generate a unique identifier that indicates the location of the LOB in the multi-thread storage system. The at least one processing node may store unique identifier. The unique identifier is accessible by all units of parallelism.

According to another aspect of the disclosure, a method may to executing, at least one unit of parallelism in each of a plurality of processing nodes. The method may further include generating, with at least one processing node, at least one LOB. The method may further include identifying, with the at least one processing node, a multi-thread storage system. The method may further include storing, with the at least one processing node, the LOB in the multi-thread storage system. The method may further include generating, with the at least one processing node, a unique identifier that indicates the location of the LOB in the multi-thread storage system. The method may further include storing, with the at least one processing node, a unique identifier. The unique identifier may accessible by all units of parallelism.

According to another aspect of the disclosure, a computer-readable medium may be encoded with a plurality of instruction executable by a process. The plurality of instructions may include instructions to execute at least one unit of parallelism in each of a plurality of processing nodes. At least one processing node may generate at least one large object (“LOB”). The at least one processing node may identify a multi-thread storage system. The at least one processing node may store the LOB in the multi-thread storage system. The at least one processing node may generate a unique identifier that indicates the location of the LOB in the multi-thread storage system. The at least one processing node may store unique identifier. The unique identifier is accessible by all units of parallelism.

### BRIEF DESCRIPTION OF THE DRAWINGS

The disclosure may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of an example analytic environment.

FIG. 2 is a detailed block diagram of a processing node.

FIG. 3 is a detailed block diagram of an optimizer module.

FIG. 4 is a detailed block diagram of a parser module.

FIG. 5 is a block diagram of a large object (“LOB”) being stored and retrieved.

FIG. 6 is a block diagram of a LOB being stored and retrieved in an object store.

FIG. 7 is an operational flow diagram of LOB storage.

### DETAILED DESCRIPTION OF THE FIGURES

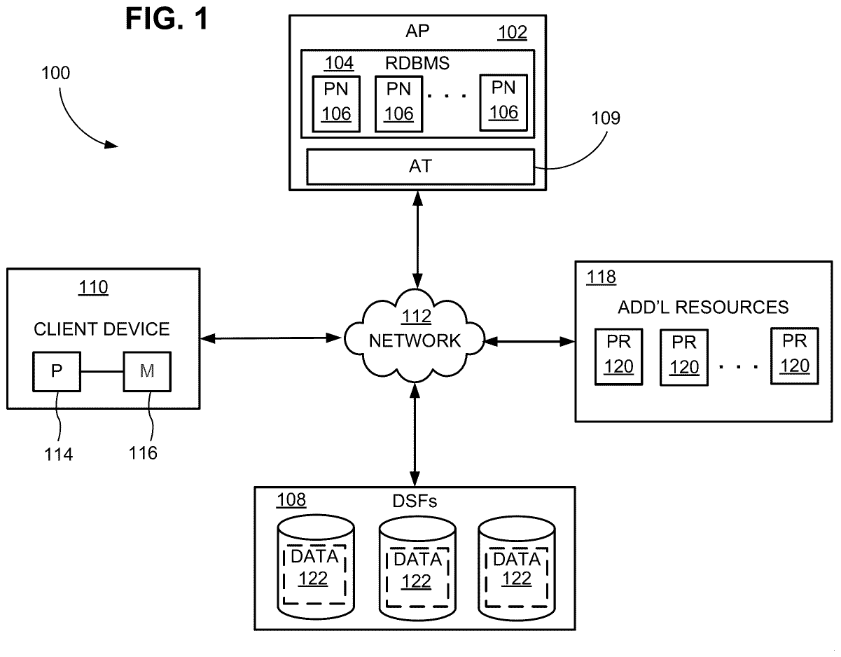

FIG. 1 is a block diagram of an example analytic environment 100. In one example, the analytic environment 100 may include an analytic platform (“AP”) 102, such as Teradata Vantage. The analytic platform 102 may include one or more systems that may be used independently or with one another in conducting advanced analytics. The analytic platform 102 may include a relational database management system (“RDBMS”) 104. In one example, the RDBMS 104 may implement a parallel-processing environment to conduct database management. The RDBMS 104 may be a combination of software (e.g., computer program routines, subroutines, applications, etc.) and hardware (e.g., processors, memory, etc.). In the example of FIG. 1, the RDBMS 104 may be a massively parallel processing (MPP) system having a number of processing nodes 106. In alternative examples, the RDBMS 104 may implement a single processing node, such as in a symmetric multiprocessing (SMP) system configuration. The RDBMS 104 may include one or more processing nodes 106 used to manage the storage, retrieval, and manipulation of data in data storage facilities (DSFs) 108. The DSFs 108 may represent various types of storage, such as persistent and/or non-persistent, for example. The processing nodes 106 may manage the storage, retrieval, and manipulation of data included in a database.

The analytic environment 100 may include a client device 110 that communicates with the analytic platform 102 via a network 112. The client device 110 may represent one or more devices, such as a graphical user interface (“GUI”), that allows user input to be received. The client device 110 may include one or more processors 114 and memory(ies) 116. The network 112 may be wired, wireless, or some combination thereof. The network 112 may be a cloud-based environment, virtual private network, web-based, directly-connected, and/or some other suitable network configuration. In one example, the client device 110 may run a dynamic workload manager (DWM) client (not shown).

The analytic environment 100 may also include additional resources 118. Additional resources 118 may include processing resources (“PR”) 120. In a cloud-based network environment, the additional resources 118 may represent additional processing resources that allow the analytic platform 102 to expand and contract processing capabilities as needed.

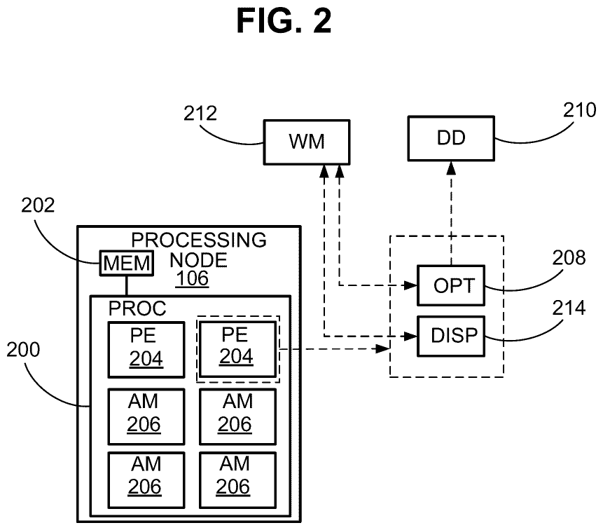

FIG. 2 is an example of a processing node 106, which may include one or more physical processors 200 and memory(ies) 202. Memory(ies) 202 may include one or more memories and may be computer-readable storage media or memories, such as a cache, buffer, random access memory (RAM), removable media, hard drive, flash drive or other computer-readable storage media. Computer-readable storage media may include various types of volatile and nonvolatile storage media. Various processing techniques may be implemented by the processors 200 such as multiprocessing, multitasking, parallel processing, and the like, for example.

The processing nodes 106 may include one or more other processing unit types such as parsing engine (PE) modules 204 and access modules (AM) 206. As described herein, each module, such as the parsing engine modules 204 and access modules 206, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively, or in addition, each module may include memory hardware, such as a portion of the memory 202, for example, which includes instructions executable with the processor 200 or other processor to implement one or more of the features of the module. When any one of the modules includes the portion of the memory 202 that comprises instructions executable with the processor, the module may or may not include the processor. In some examples, each module may just be the portion of the memory 202 or other physical memory that comprises instructions executable with the processor 200 or other processor to implement the features of the corresponding module without the module including any other hardware. Because each module includes at least some hardware even when the included hardware comprises software, each module may be interchangeably referred to as a hardware module, such as the parsing engine hardware module or the access hardware module. The access modules 206 may be access modules processors (AMPs), such as those implemented in the Teradata Vantage analytic platform, for example.

The parsing engine modules 204 and the access modules 206 may each be virtual processors (vprocs) and/or physical processors. In the case of virtual processors, the parsing engine modules 204 and access modules 206 may be executed by one or more physical processors, such as those that may be included in the processing nodes 106. For example, in FIGS. 1-2, each parsing engine module 204 and access module 206 is associated with a respective processing node 106 and may each be executed as one or more virtual processors by physical processors 200 included in the respective processing node 106.

In FIG. 2, each processing node 106 is shown as including multiple parsing engine modules 204 and access modules 206, such that there are more parsing engine modules 204 and access modules 206 than processing nodes 106. In one example, during operation, the one or more physical processors 200 included in the processing nodes 106 may execute the parsing engine modules 204 and access modules 206 by switching between the executions of the various modules at a rapid rate allowing the vprocs to substantially operate in “parallel.”

The RDBMS 104 stores data 122 in one or more tables (or other data object formats) in the DSFs 108. In one example, the data 122 may represent rows of stored tables that are distributed across the DSFs 108 and in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket.” The hash buckets are assigned to DSFs 108 and associated access modules 206 by a hash bucket map. The characteristics of the columns chosen for the primary index determine how evenly the rows are distributed.

Rows of each stored table may be stored across multiple DSFs 108. Each parsing engine module 204 may organize the storage of data and the distribution of table rows. The parsing engine modules 204 may also coordinate the retrieval of data from the DSFs 108 in response to queries received, such as those received from a client system 108 connected to the RDBMS 104 through connection with a network 112.

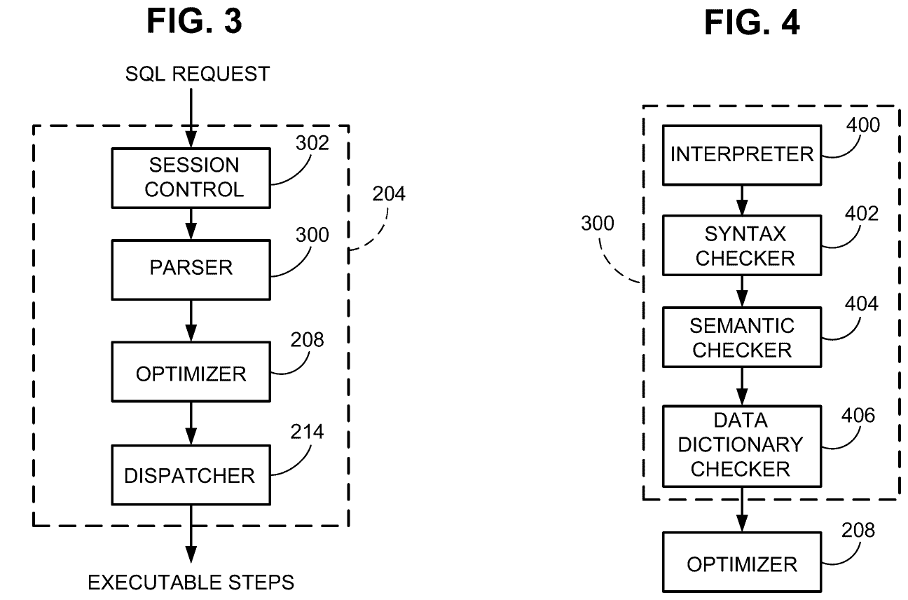

Each parsing engine module 204, upon receiving an incoming database query may apply an optimizer module 208 to assess the best plan for execution of the query. An example of an optimizer module 208 is shown in FIG. 2 with regard to a parsing engine module 204. Additional description of the parsing engine modules 204 is provided with regard to FIGS. 3 and 4. Selecting the optimal query-execution plan may include, among other things, identifying which of the processing nodes 106 are involved in executing the query and which database tables are involved in the query, as well as choosing which data-manipulation techniques will serve best in satisfying the conditions of the query. To this end, for each parsing engine module 204, a parser module 300 (see FIG. 3), and/or optimizer module 208 may access a data dictionary module 210, shown in FIG. 2 specifically for parsing engine module 204 for purposes of illustration.

The data dictionary module 210, which may reside in the RDBMS 104, may specify the organization, contents, and conventions of one or more databases, such as the names and descriptions of various tables maintained by the RDBMS 104 as well as fields/columns of each database, for example. Further, the data dictionary module 210 may specify the type, length, and/or other various characteristics of the stored tables. The RDBMS 104 typically receives queries in a standard format, such as the structured query language (SQL) put forth by the American National Standards Institute (ANSI). However, other languages and techniques, such as contextual query language (CQL), data mining extensions (DMX), and multidimensional expressions (MDX), graph queries, analytical queries, machine learning (ML), large language modes (LLM) and artificial intelligence (AI), for example, may be implemented in the RDBMS 104 separately or in conjunction with SQL. The data dictionary 210 may be stored in the DSFs 108 or some other storage device and selectively accessed.

The RDBMS 104 may include a workload management system workload management (WM) module 212, which may be executed within the RDBMS 104 by one or more processing nodes 106. The WM module 212 may be implemented as a “closed-loop” system management (CLSM) architecture capable of satisfying a set of workload-specific goals. In other words, the RDBMS 104 is a goal-oriented workload management system capable of supporting complex workloads and capable of self-adjusting to various types of workloads. The WM module 212 may communicate with each optimizer module 208, as shown in FIG. 2, and is adapted to convey a confidence threshold parameter and associated parameters to the optimizer module 208 in communication. Further, the WM module 212 may communicate with a dispatcher module 214 of each parsing engine module 206 (as shown in detail in FIG. 2 for parsing engine module 206) to receive query execution plan costs therefrom, and to facilitate query exception monitoring and automated modifications of confidence threshold parameters in accordance with disclosed embodiments.

The WM module 212 operation has four major phases: 1) assigning a set of incoming request characteristics to workload groups, assigning the workload groups to priority classes, and assigning goals (referred to as Service Level Goals or SLGs) to the workload groups; 2) monitoring the execution of the workload groups against their goals; 3) regulating (e.g. adjusting and managing) the workload flow and priorities to achieve the SLGs; and 4) correlating the results of the workload and taking action to improve performance. In accordance with disclosed embodiments, the WM module 212 is adapted to facilitate control of the optimizer module 208 pursuit of robustness with regard to workloads or queries.

An interconnection (not shown) allows communication to occur within and between each processing node 106. For example, implementation of the interconnection provides media within and between each processing node 106 allowing communication among the various processing units. Such communication among the processing units may include communication between parsing engine modules 204 associated with the same or different processing nodes 106, as well as communication between the parsing engine modules 204 and the access modules 206 associated with the same or different processing nodes 106. Through the interconnection, the access modules 206 may also communicate with one another within the same associated processing node 106 or other processing nodes 106.

The interconnection may be hardware, software, or some combination thereof. In instances of at least a partial-hardware implementation the interconnection, the hardware may exist separately from any hardware (e.g., processors, memory, physical wires, etc.) included in the processing nodes 106 or may use hardware common to the processing nodes 106. In instances of at least a partial-software implementation of the interconnection, the software may be stored and executed on one or more of the memories 202 and processors 200 of the processing nodes 106 or may be stored and executed on separate memories and processors that are in communication with the processing nodes 106. In one example, the interconnection may include multi-channel media such that if one channel ceases to properly function, another channel may be used. Additionally, or alternatively, more than one channel may also allow distributed communication to reduce the possibility of an undesired level of communication congestion among processing nodes 106.

In one example system, each parsing engine module 206 includes three primary components: a session control module 302, a parser module 300, and the dispatcher module 214 as shown in FIG. 3. The session control module 300 provides the logon and logoff functions. It accepts a request for authorization to access the database, verifies it, and then either allows or disallows the access. Once the session control module 302 allows a session to begin, a SQL request may be received such as through submission the client device 110 and the SQL request is routed to the parser module 300.

As illustrated in FIG. 4, the parser module 300 may include an interpreter module 400 that interprets the SQL request. The parser module 300 may also include a syntax checker module 402 that checks the request for correct SQL syntax, as well as a semantic checker module 404 that evaluates the request semantically. The parser module 302 may additionally include a data dictionary checker 406 to ensure that all of the objects specified in the SQL request exist and that the user has the authority to perform the request. The parsing engine module 206 implements the optimizer module 208 to select the least expensive plan to perform the request, and the dispatcher 214 coordinates the runtime execution of executable steps of the query execution plan of the optimizer module 208 with the access modules 206.

In one example, to facilitate implementations of automated adaptive query execution strategies, such as the examples described herein, the WM module 212 monitoring takes place by communicating with the dispatcher module 214 as it checks the query execution step responses from the access modules 206. The step responses include the actual cost information, which the dispatcher module 214 may then communicate to the WM module 212 which, in turn, compares the actual cost information with the estimated costs of the optimizer module 208.

Advances in database technology have allowed large objects (“LOBs”) to be implemented. However, due to the size of most LOBs, some databases may experience difficulties in optimizing their usage. For example, in the RDBMS 104, LOBs may be owned by a single access module 206. In order for others access modules 206 to use the LOB, it must be sent to each access module 206 requesting use. This creates a “one-to-many” problem in which a single access module 206 must service the requests of many other access modules 206. Due to the size of the LOBs, it may be impossible to service all requests without system timeouts occurring or may be so time-consuming, query processing is infeasible.

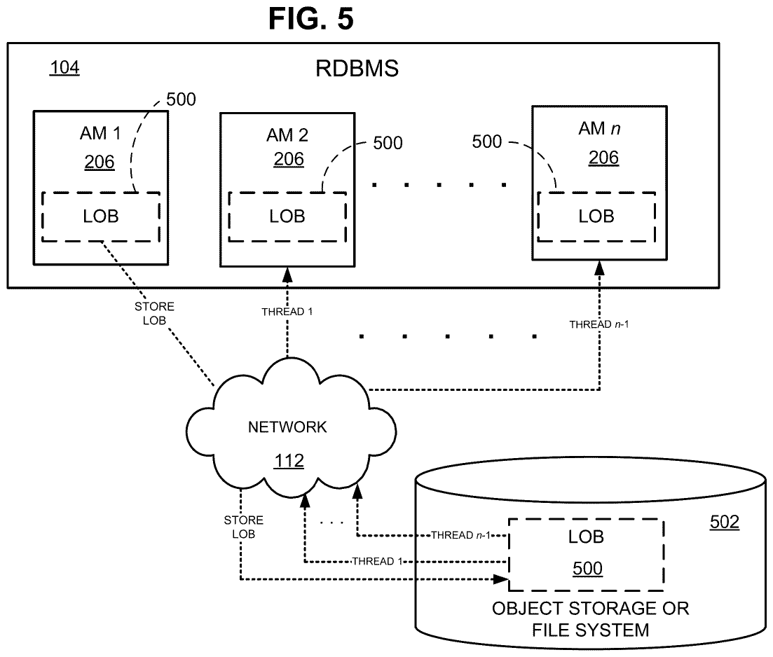

In one example, cloud or on-premises storage configured to service multiple threads may be used to alleviate this issue. FIG. 5 is a block diagram of an example of the RDBMS 104 implementing a solution to allow more flexibility in implementing LOBs. In one example, a number n of access modules 206 in the RDBMS 104 are shown. The access module AM 1 has access to LOB 500. In one example, the access module AM 1 may store the LOB 500 in object storage or a file system 502.

Cloud-based and on-premises object storage and file systems 502 may allow multithread access in which more than one request can be serviced simultaneously. In the example of FIG. 5, access modules 2 through n are requesting a copy of the LOB 500, which may be provided in threads 1 through n-1. By using the features of the object storage or file system, the RDBMS 104 may circumvent the issue of a single access module 206 attempting to replicate a LOB across multiple other access modules 206.

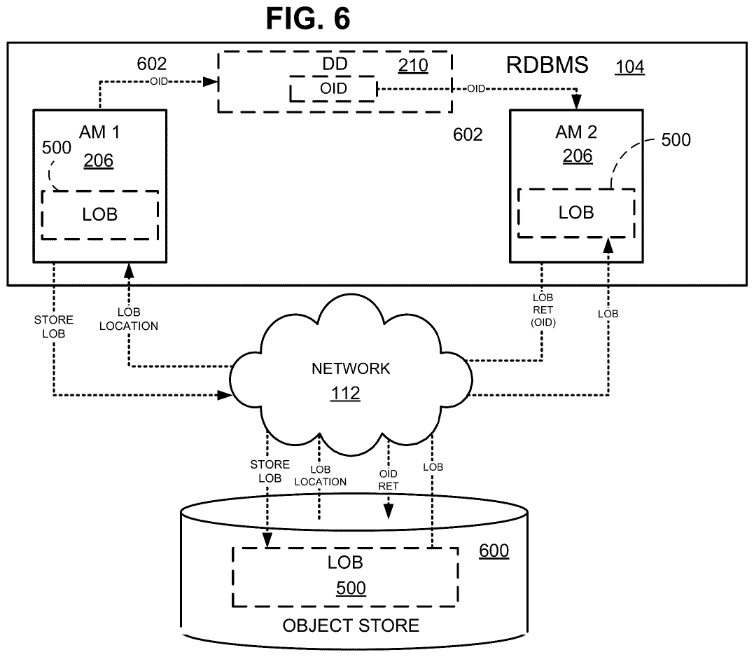

As described in FIG. 5, an object storage or a file system 502 may be used to service multiple LOB requests concurrently. FIG. 6 is an example of the interaction between object storage 600, such as Amazon S3, and the RDBMS 104. In one example, access module AM 1 may create the LOB 502 and store it in the object store 600. A location within the object store may be generated (i.e., s3://tioce/embeddings/arxiv/pdf/001474747) and returned to the access module AM 1. The access module AM 1 may generate a unique object identifier (“OID”) 602 based on the location of the LOB 500. The OID 602 may contain other information regarding the LOB 500, such as a kind code that indicates the type of storage (i.e., “3” for object store or “4” for file system) used for the LOB 500. The OID 600 may be stored in the data dictionary 210. In the example of a file system, the access module AM 1 may receive a folder location in the file system to include as the OID. The LOBs described may include large language models (“LLMs”), which may be trained on a single access module 206 and stored for parallel usage by the access modules. Each access module 206 may also train a model using only rows that it owns with each model being stored separately.

Other access modules 206 may using the OID 600 to retrieve the LOB when needed. FIG. 6 is an example of the access module AM 2 retrieving the LOB 500. In one example, the access module AM 2 may retrieve the OID 600 from the data dictionary 210. The access module AM 2 may retrieve the LOB 500 from the object store 600 using the OID 602 to determine the location of the LOB 500 within the object store 600. The LOB 500 may be sent from the object store 600 to the access module AM 2.

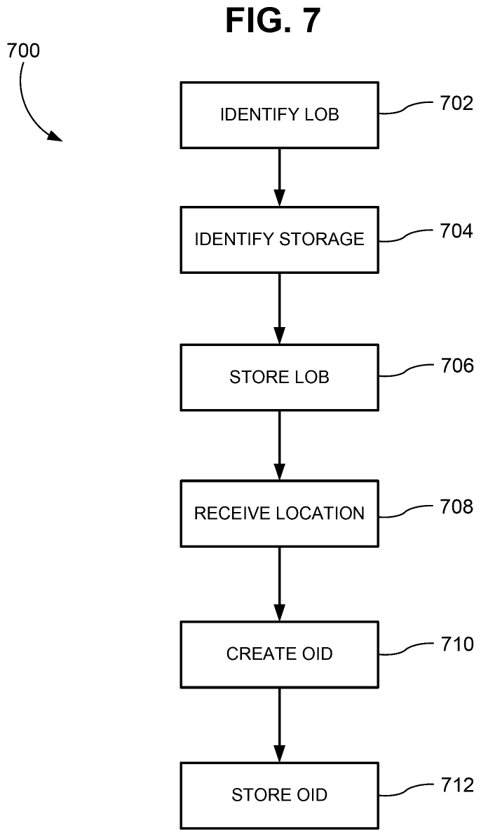

FIG. 7 is an operational flow diagram 700 of an example storing by an access module 206 of a LOB to object storage 600. In one example, the access module 206 may identify the LOB, which may be through creation of the LOB or manner of identification (702). The access module 206 may identify the object storage 600 to receive the LOB, such as Amazon S3 (704). The access module 206 may store the LOB in the object storage 600. The access module 206 may receive the location at which the LOB is stored (708). Based on the location, an OID may be created by the access module 206 using the location of the where the LOB is stored in the object storage (710). The OID may be stored by the access module 206.

While various embodiments of the disclosure have been described, it will be apparent to those of ordinary skill in the art that many more embodiments and implementations are possible within the scope of the disclosure. Accordingly, the disclosure is not to be restricted except in light of the attached claims and their equivalents.

1. A system comprising:
a storage device configured to store a database;
a plurality of processing nodes in communication with the storage device, wherein each processing node is configured to execute at least one unit of parallelism, and wherein at least one processing node is configured to:
generate at least one large object (“LOB”);
identify a multi-thread storage system;
store the LOB in the multi-thread storage system;
generate a unique identifier that indicates the location of the LOB in the multi-thread storage system;
store a unique identifier, wherein the unique identifier is accessible by all units of parallelism; and
receive a query, wherein, in response to receipt of the query, a plurality of units of parallelism concurrently retrieves the LOB from the multi-thread storage system, wherein at least on unit of parallelism is associated with a processing node different from the other units of parallelism.

2. The system of claim 1, wherein the multi-thread storage system comprises an object store.

3. The system of claim 1, wherein the database comprises a plurality of tables, and wherein each unit of parallelism is uniquely associated with a plurality of rows of a table from the plurality of tables, and wherein, in response to receipt of the query, the each of unit of parallelism is configured to execute the retrieved LOB on the uniquely associated plurality of rows.

4. The system of claim 1, wherein the LOB is a large language model (“LLM”).

5. The system of claim 1, wherein each unit of parallelism uses the unique identifier to retrieve the LOB.

6. A method comprising:
generating, with at least one processor from a plurality of processors, at least one large object (“LOB”);
identifying, with the at least one processor, a multi-thread storage system;
storing, with the least one processor, the LOB in the multi-thread storage system;
generating, with the at least one processor, a unique identifier that indicates the location of the LOB in the multi-thread storage system;
storing, with the at least one processor, a unique identifier, wherein the unique identifier is accessible by all units of parallelism; and
receiving, with the at least one processor, a query, wherein each processor in the plurality of processors is configured to execute at least one unit of parallelism, wherein, in response to receipt of the query, retrieving, with a plurality of units of parallelism, the LOB from the multi-thread storage system, wherein at least on unit of parallelism of the plurality of units of parallelism is associated with a processor different from the other units of parallelism.

7. The method of claim 6, wherein the multi-thread storage system comprises an object store.

8. The method of claim 6, further comprising:
storing, with the at least one processor, a database comprising a plurality of tables, and wherein each unit of parallelism is uniquely associated with a plurality of rows of a table from the plurality of tables; and
in response to receipt of the query, executing, with each unit of parallelism, the retrieved LOB on the uniquely associated plurality of rows.

9. The method of claim 6, wherein the LOB is a large language model (“LLM”).

10. The method of claim 6, wherein each unit of parallelism uses the unique identifier to retrieve the LOB.

11. A non-transitory computer-readable medium encoded with a plurality of instructions executable by a processor, the plurality of instructions comprising:
instructions to generating, with at least one processor from a plurality of processors, at least one large object (“LOB”);
instructions to identify a multi-thread storage system;
instructions to store the LOB in the multi-thread storage system;
instructions to generate a unique identifier that indicates the location of the LOB in the multi-thread storage system;
instructions to store a unique identifier, wherein the unique identifier is accessible by all units of parallelism; and
instructions to receive a query, wherein each processor in the plurality of processors is configured to execute at least one unit of parallelism, wherein, in response to receipt of the query, retrieving, with a plurality of units of parallelism, the LOB from the multi-thread storage system, wherein at least on unit of parallelism of the plurality of units of parallelism is associated with a processor different from the other units of parallelism.

12. The non-transitory computer-readable medium of claim 11, wherein the multi-thread storage system comprises an object store.

13. The non-transitory computer-readable medium of claim 11, the plurality of instructions further comprising:
instructions to store a database comprising a plurality of tables, and wherein each unit of parallelism is uniquely associated with a plurality of rows of a table from the plurality of tables; and
in response to receipt of the query, instructions to execute, with each unit of parallelism, the retrieved LOB on the uniquely associated plurality of rows.

14. The non-transitory computer-readable medium of claim 11, wherein the LOB is a large language model (“LLM”).

15. The non-transitory computer-readable medium of claim 11, wherein each unit of parallelism uses the unique identifier to retrieve the LOB.
